(19) United States
(12) Patent Application Publication
(10) Pub. No.: US 2015/0032685 A1
(43) Pub. Date: Jan. 29, 2015

(54) VISUALIZATION AND COMPARISON OF BUSINESS INTELLIGENCE REPORTS

(71) Applicant: HARISH KUMAR LINGAPPA, BANGALORE (IN)

(72) Inventor: HARISH KUMAR LINGAPPA, BANGALORE (IN)

(21) Appl. No.: 13/948,266

(22) Filed: Jul. 23, 2013

(51) Int. Cl. G06F 17/30

(52) U.S. Cl. CPC G06F 17/30601
USPC 707/603

(57) ABSTRACT

A scale for a first business intelligence (BI) report is determined and filters over data properties of received BI data are applied. A first BI report is generated. A second BI report based on the same BI data is generated for comparing with the first BI report. For the generation of the second BI report, the same data properties are filtered as for the first BI report. The first and the second BI reports use a common scale and are displayed as two layers placed one on top of the other. In some aspects, multiple other BI reports are generated and visualized for comparative study together with the first and second BI reports as overlapping layers. These multiple BI reports share the same scale as defined for the first BI report and include filters for the same data properties as for the first BI report.

### BACKGROUND

Enterprise data is generated at a high speed, mostly within corporate computer systems. Organizations can gain business value by exploring and analyzing such data, e.g. data generated within the enterprise or other raw data from internal or external sources (e.g. social media). Business intelligence (BI) refers to a variety of software products (applications) that may be used to analyze an organization's raw data. Different BI techniques may be utilized to transform the raw data into meaningful and useful information that can serve a number of business purposes, such as to improve decision making. Self-service business intelligence (SSBI) is an approach to data analytics that enables business users to access and work with corporate information.

A number of tools and features exist for presenting complex multidimensional data. BI applications use data gathered from data warehouses or other data sources. Such BI applications may be applied for analytic purposes to build quantitative information that may help to arrive at optimal decisions and increase the business awareness. For example, BI applications may display charts and diagrams defined based on the analyzed data.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating an embodiment of an environment for generating a BI report.

FIG. 2 is a block diagram illustrating an embodiment of a system for generating BI reports.

FIG. 3 is a block diagram illustrating an embodiment of an environment for generating multiple BI reports that may be visualized as overlapping layers for easy report comparison.

FIG. 4 is an exemplary screenshot, depicting an embodiment of an environment for visualizing two BI reports, generated for comparative study, placed one over the other,

FIG. 5 is an exemplary screenshot, depicting an embodiment of an environment for visualizing two BI reports, generated for comparative study, with the use of hierarchical navigation controls.

FIG. 6 is a flow chart, depicting an embodiment of a method for generation and visualization of BI reports for comparative study.

FIG. 7 is an exemplary screenshot, depicting an embodiment of an environment for visualizing multiple BI reports, with the use of switching controls provided by a graphical user interface.

FIG. 8 is a block diagram, depicting an embodiment of a system for generating multiple BI reports with the use of hierarchical navigation controls.

FIG. 9 is a flow chart, depicting an embodiment of a method for generation of two BI reports over comparative BI data, sharing a common scale and different filters for common data properties.

FIG. 10 is a block diagram illustrating an embodiment of a computing environment in which the techniques described for perfuming a comparative study over business intelligence data can be implemented.

### DETAILED DESCRIPTION

Embodiments of techniques for visualization and comparison of business intelligence reports data are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

An organization invests heavily in building and maintaining BI systems and analytics to improve the decision-making process. Different BI solutions help organizations of all sizes thrive by enabling them to define new plans, to optimize business operations, seize market opportunities, etc. Such analytical software may allow users (customers) to gain insight into different aspects of their business and plan for the future. However, charts, diagrams, graphs that are generated by such BI solutions, may be not be treated as the end point of the provided analysis. For example, charts may be viewed as a starting point for gaining valuable insights over the explored data. Comparative studies may be performing based on generated charts.

Enterprises solve different type of problems by analyzing business intelligence reports, which are of their area of interest. To gain the targeted information, a user may create multiple reports based on data spread at multiple places and put the reports side by side to perform comparative study. The comparative study is valuable as it may navigate and suggest corrective actions if needed. This process is time consuming and usually needs support from additional software tools and other information technology (IT) resources. SSBI includes products that target this area of interest and propose solutions for generating different types of charts and graphs, based on BI data. In one embodiment, SSBI may add additional value by offering tools and methods for performing comparative studies for less time and with less education for end users.

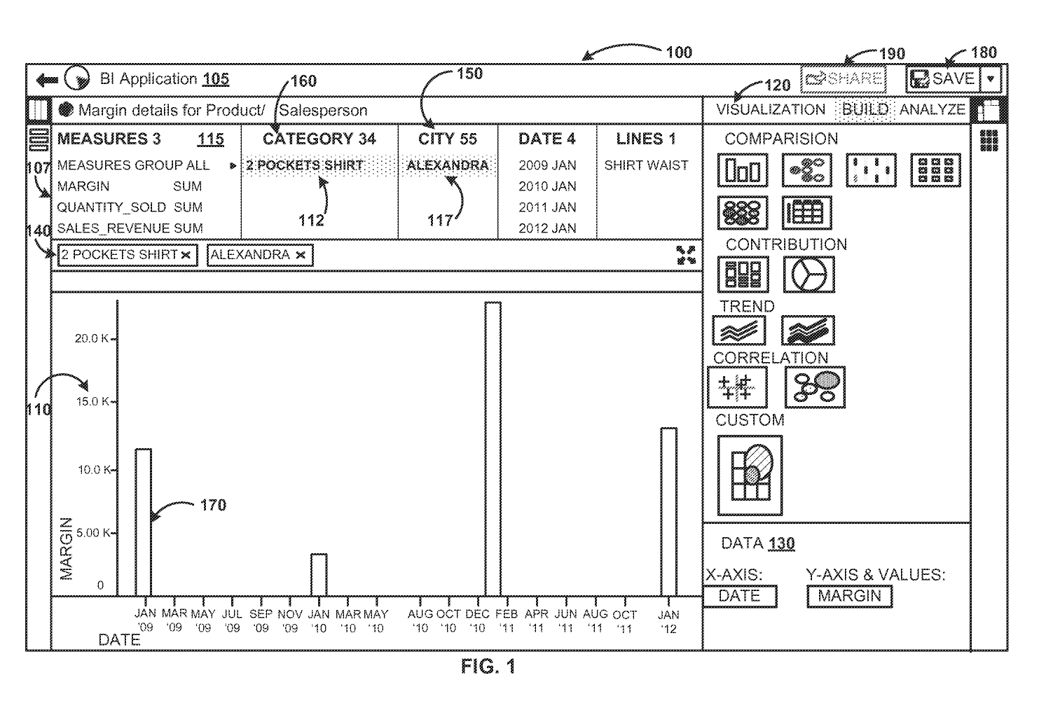

FIG. 1 is a block diagram illustrating an embodiment of an environment 100 for generating a BI report 110. A BI application 105 is used for generating the BI report 110 by filtering BI data. The BI data describes the sales of a company that has a number of salespeople that work in different cities and with different product categories. In one embodiment, data may be stored in data tables with columns and rows. The analysis type of a column may be classified as a measure or a dimension. In one embodiment, columns may be interpreted as data properties that characterize the BI data. Columns that include qualitative data may be classified as dimensions, and columns that include quantitative, numeric data may be classified as measures. For example, a value that is a function of one or more dimensions may be classified as a measure. Table 107 presents the measures 115 and dimensions that characterize the stored data used for generating the BI report 110. The presented measures are MARGIN, QUANTITY_SOLD, and SALES_REVENUE. If a given column qualifies as a measure, appropriate aggregation type may be determined. For example, the aggregation type may be an aggregation method characterizing the measure, e.g. sum, average, and count. The measure MARGIN has an aggregation type—“SUM”. The QUANTITY_SOLD and SALES_REVENUE also have an aggregation type “SUM”, which is displayed in the first column of the table 107, on the right, next to each of the measures.

In one embodiment, the BI report 110 is generated by a salesperson that is responsible for product category named “2 pocket shirt” 112, who sells this product in city—ALEXANDRA 117. For example, the BI report 110 is in form of a chart such as a bar chart. The chart uses a scale that defines the aspects that are used for presenting information. The salesperson generates the chart to determine the margins per date that he has accumulated by selling the product “2 pocket shirt” 112 in the city ALEXANDRA 117. Therefore, a scale is determined, which includes margin and data. The determined scale may be presented as x-axis and y-axis within a coordinate system and the two dimensions of the scale are marked in the data 130 section, below a visualization 120 section. In another embodiment, the scale may comprise more than two dimensions. In one embodiment, when determining a scale for building a chart, quantitative characteristics (data properties) of the BI data are chosen for the scale. Margin is a measure characterizing the performed sales made by the company that the salesperson works for.

In one embodiment, when the salesperson is logged in the BI application 105, and generates a report, the data presented in a BI report may be filtered and includes only data relevant for sales performance of the salesperson. In another embodiment, the generated report may include all of the data about performed sales by all of the salespeople that work for the given company. The chart that may be generated can be in different forms, such as the suggested forms in the Visualization 120 section. For example, that chart can be a bar chart, a pie chart, a trend chart, a line chart, etc. At filtering section 140 within the BI application 105, the determined filters for generating the report are displayed. The filtering may be performed by selecting a category, a city, a data, a line, or more than one of those, from the dimensions displayed in the table 107. For the generation of the BI report 110, a filtering is defined with a filtering criteria for the product “2 pocket shirt” 112 and city ALEXANDRA 117, which are selected within the table 107 and then presented in the filtering section 140. When a filter is defined, it may be removed or changed. For example, if the salesperson is interested only in the margin for a given product without specifying the city where the product is sold, the salesperson may not use a filter for a city data property 150. In the current example, the city data property 150 includes values for 55 different cities, where products from the list in category 160 data property are for sale. The category 160 data property includes 34 products, one of which is the “2 pockets shirt” 112. The BI report 110 is generated based on the defined scale (in the data 130 section) and the defined filters (in the filtering section 140), and a bar chart is visualized, which means that the bar chart is displayed, e.g. on a graphical user interface (GUI). The bar chart includes 4 bars that present data for 4 defined dates, because in the date dimension there are only 4 date values—2009 January, 2010 January, 2011 January, 2012 January. For example, bar 170 displays the sum of margins received for January, 2009 for the product “2 pocket shirt” 112, in city ALEXANDRA 117, by the salesperson that generates the report. In another embodiment, the displayed bar in such a bar chart may present the sum of margins received for January, 2009 for the product “2 pocket shirt” 112, in city ALEXANDRA 117, by all of the salespeople that work for a company. The generated BI report may be saved and/or shared, using the save 180 control and/or the share 190 control.

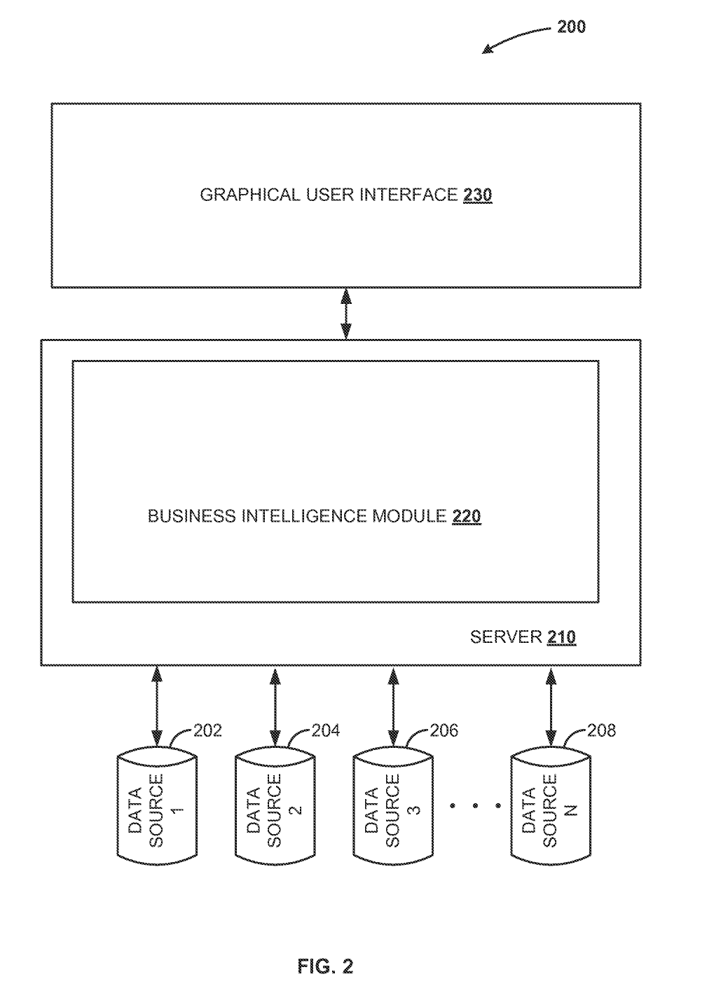

FIG. 2 is a block diagram illustrating an embodiment of a system 200 for generating BI reports. The system 200 includes a server 210. A business intelligence (BI) module 220 runs on the server 210. The BI module 220 may be a BI application, such as the BI application 105 discussed in relation to FIG. 1. The BI module 220 receives data from data sources 1 202, data sources 2 202, data sources 3 206, through data sources N 208. The data sources provide useful business data to the BI module 220. The BI module 220 may use this data to perform operations over the data and generate valuable reports that lead to better strategic decisions in a business field. The generated report, such as the BI report 110 in FIG. 1, may be displayed on a Graphical User Interface (GUI) 230. The GUI 230 may provide additional tools and options for presenting reports in a preferred format and sizing. Also, the GUI 230 may provide simple controls for switching between different modes of visualization. The GUI 230 together with the BI module 220 may be further extended to provide capabilities for easier comparison of BI reports that share a common scale for presentation. The GUI 230 may provide simple GUI controls to “zoom in” or “zoom out” within a dimension filtered for a given report, thus to generate a second comparative report. The generation of two reports that are visualized for easy comparison may be performed with just a couple of mouse clicks.

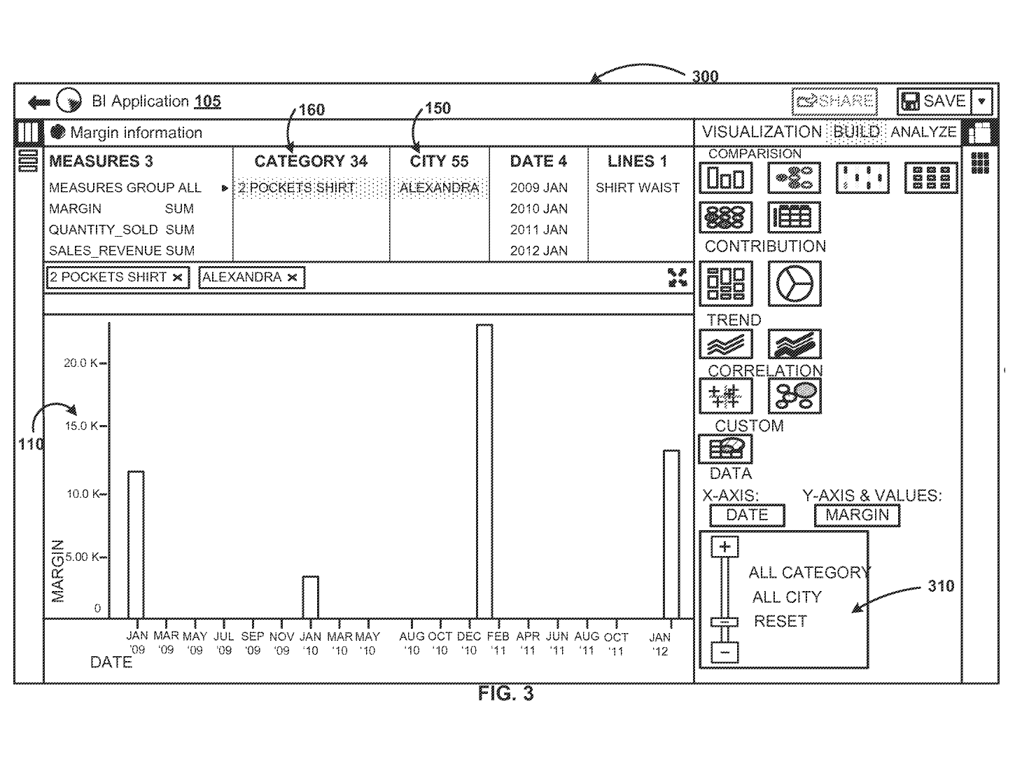

FIG. 3 is a block diagram illustrating an embodiment of an environment 300 for generating multiple BI reports that may be visualized as overlapping layers for easy report comparison. A following scenario may occur for a salesperson, such as the salesperson discussed during the description of FIG. 1. If the salesperson is responsible for sales of a product, named “2 Pocket shirts”, in city “Alexandra” and the salesperson has to analyze margin information, then he/she has to follow some steps to create a BI report (for example SSBI report). In one embodiment, the salesperson may use the BI application 105 (FIG. 1) and generate a report based on received BI data, such as the BI report 110 (FIG. 1), which corresponds to the same product and city. In one embodiment, the salesperson, as a user of the BI application 105 may select a data source which contains the margin information for the given product, city and other associated dimensions. Further, the user may create an analytic report by dragging the measure “Margin” on to Y-axis and dimension “Date” on to X-axis. After determining a scale for the report, the user may filter the margin by selecting value “2 Pocket shirts” from available products in the Category 160 (FIG. 1) list and “Alexandra” from available City 150 (FIG. 1) value list. The report with margin information may be displayed as shown in FIG. 1. After creating this analytic view, there may be further option—to apply other further filters, to change the chart type, and to save the desired result.

In one embodiment, if the user (e.g. salesperson) would like to compare the margin report for a product and a city, he/she is responsible for, across all other cities and/or products, he/she will be challenged. First, the user may generate another BI report that is a comparative report that may be used for a comparative study with the previously generated report with margin information about the performance. The comparative report may be generated for margin information regarding other products, cities, other salesperson, or other criteria that can be extracted from the data properties of the used BI data. The end user may create multiple visualizations and start comparing them by keeping them side by side. However, if user controls, such as user controls 310, are provided by the BI application 105, the task for performing a comparative study may be accomplished in an easier and more accurate manner. The enhancement of the GUI proposed with the user controls 310 may help the end users solve issues by just couple of clicks and with less effort of comparison.

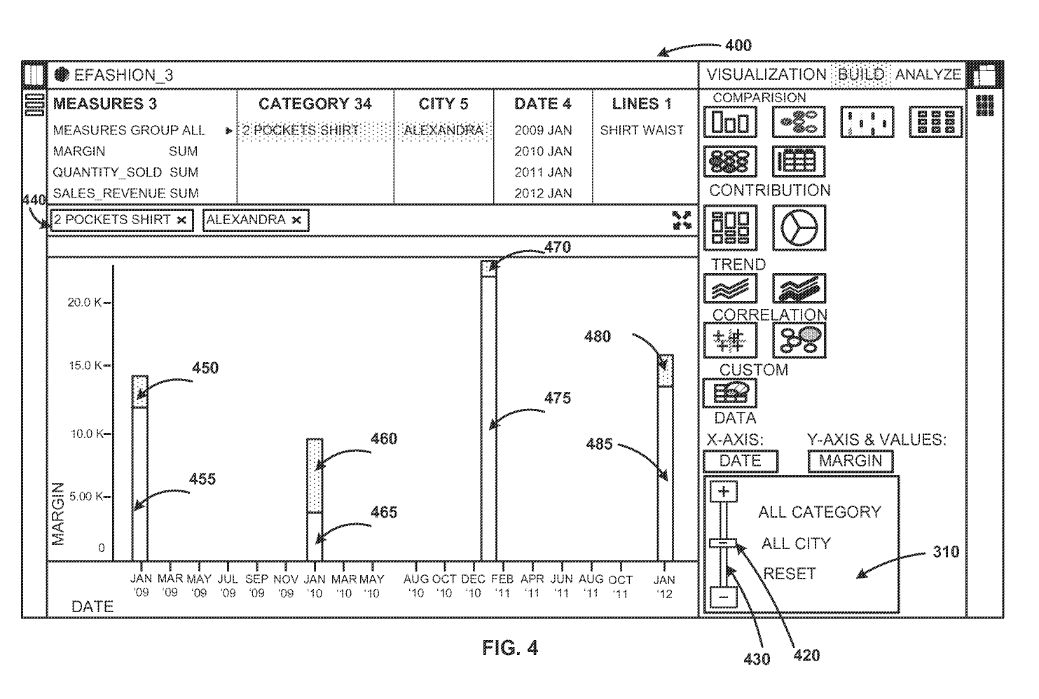

FIG. 4 is an exemplary screenshot, depicting an embodiment of an environment 400 for visualizing two BI reports, generated for comparative study, placed one over the other. In one embodiment, the environment 400 may be such as the environment 300. With the use of a BI application, BI reports may be built and visualized. User controls 310, such as the user controls 310 in FIG. 3, may allow a user of the BI application to get a closer look into information about margins for all of the cities, not only the city that is specified with a filtering criteria—“ALEXANDRA”. To generate such a report, the user may use the zoom in option and move a navigation control 420 up on a navigation scale 430. If the navigation control 420 is moved to the second position “ALL CITY”, then a second report is generated that has the same scale—Margin and Date, as the previously generated one. The second report changes just one of the filtering criteria from the filters defined at section 440. The second position on the navigation scale 430 makes a change on the lowest level of filtering that is defined for the first report, which is the filtering with criteria “ALEXANDRA”. The second report that may be generated by moving the navigation control 420 up in the navigation scale 430 to the second position “ALL CITY” may use a filtering criteria for the data property “CITY”. In one embodiment, the second report filters the dimensions “CATEGORY” and “CITY”, but the filtering for the “CITY” dimension is not only for the city “Alexandra”, but for all of the cities (in this example, they are 55). The filtering for the dimension “CATEGORY” is kept untouched. In another embodiment, the filtering for the “CITY” dimension may apply to all of the cities defined as values for the data property “CITY” in the BI data, except for the city “Alexandra”, which was targeted for the firstly generated report.

In one embodiment, the visualization of a firstly generated BI report (first BI report), such as the BI report 110 (FIG. 1), may be presented in the GUI. The secondly generated BI report (second BI report), which is generated with the use of the user controls 310 by moving the navigation control 420 to the second position may be visualized as an overlapping layer behind the first BI report. The visualization of the first BI report may stay intact, and the second BI report may be visualized by placing the second BI report exactly behind the first BI report. In such a manner, the two reports will be placed one on top of the other. The visualization can be accomplished because the scale for the first BI report is same as for the second BI report. The reports use common BI data and the filtered data properties of the BI data are preserved with just one change of the filtering criteria for a data property. Filtering may be applied over the dimensions describing quantitative and qualitative characteristics of the source data.

In one embodiment, the change in the filtering for the second BI report is applied to the lowest level of defined filtering for the first BI report. The BI data may be hierarchical data and the data properties of the BI data that are classified as dimensions define hierarchy levels. Keeping a current chart view intact, which describes margin information for the selected product and city, and having the user controls 310, allows a user to slap another layer of chart on top of the existing view (with two report). Margin information can be further compared based on other filtering criteria for the already filtered dimensions or other dimensions. The second BI report that is generated may include bars 450, 460, 470, and 480 that stay behind bars 455, 465, 475, and 485, which are part of the first BI report. The bars 455, 465, 475, and 485 in FIG. 4 may correspond to bars of a chart, such as the chart representing BI report 110 in FIG. 3. In one embodiment, BI data used for generating the bars 455, 465, 475, and 485, may comprise data similar to data used for the BI report 110 in FIG. 3 but for 5 cities only. When a user selects and moves up the navigation control 420, the first BI report retains on the screen and another layer of a chart, with margin details calculated for all of the cities, is slapped behind. The bars from the second BI report may present margin information, such as the average number of margins per city, or the sum of margins for all of the cities, or another aggregation of the margin information for the cities that are part of the BI data. Such options may be provided with additional GUI controls, associated with the navigation controls 420. With the use of the additional GUI controls a user may specify different options for applying filtering criteria for the corresponding filtered data property (dimension). The user controls 310 provide options for moving across all of the filtered data properties defined in the first BI report. When placing the bars of a chart one over the other, there is an overlapping area. In one embodiment, the overlapping are may be with a different color and transparency level so that the original chart is also available and visible for comparison.

Consider the above examples connected to sales data. For example, sales data is associated with sales managers that manage a team of salespeople. The hierarchical levels associated with such sales data represent dimensions like: (bottom-up)—Margin, Product, Sales Person, Region and Sales Manager, etc. The dimensions represented at the hierarchical levels include: sales margin for Sales manager A; products (P1, P2, P3, P4, P5, P6, P7) under sales manager A; Sales Persons SP1, SP2, SP3 under Sales manager A; Region Asia Pacific Japan (APJ), Europe, the Middle East and Africa(EMEA), Americas; and Sales Manager A. The suggested hierarchy levels are not limited to the provided examples. In some alternatives, the sales manager may not be only one, but a team of sales manager that are leaded by a managing director, or a vice president, or other representative of the given company.

In some scenarios, a couple of BI reports may be generated and visualized as overlapping graphs that represent sales person's margin per date. By such a visualization, sales manager A will be provided with insights about the individual performances of a salesperson on a single diagram including two graphs. In another embodiment, a couple of graphs are generated for a single sales person and visualized simultaneously one over the other for an easy comparison. For example, each of the graphs may reflect the margin per date information for a single product that was for sale in a couple of towns. Such a comparison may be useful in a lot of business scenarios when a company is analyzing their market share and there is a need for some regions to invest more to increase the income. Another example for performing a comparative study by generating BI reports that are visualized one on top of another is when two sales representatives manage different product and they want to compare their contribution to the company's financial benefits. In such a situation, a coordinate system may be used for visualizing two charts, corresponding to two BI reports. The two charts may share common axes' scales having similar measures, and the graphs may give information for disconnected products, e.g. salesperson 1 is responsible for product 1 and product 2, and salesperson 2 is responsible for product 3 and product 4. The two BI reports may be generated and overlaid when rendered on a screen, e.g. part of a BI application. The user controls 310 mat help with various levels of overlapping of multiple charts by navigation between the hierarchy levels defined by measures that describe the BI data.

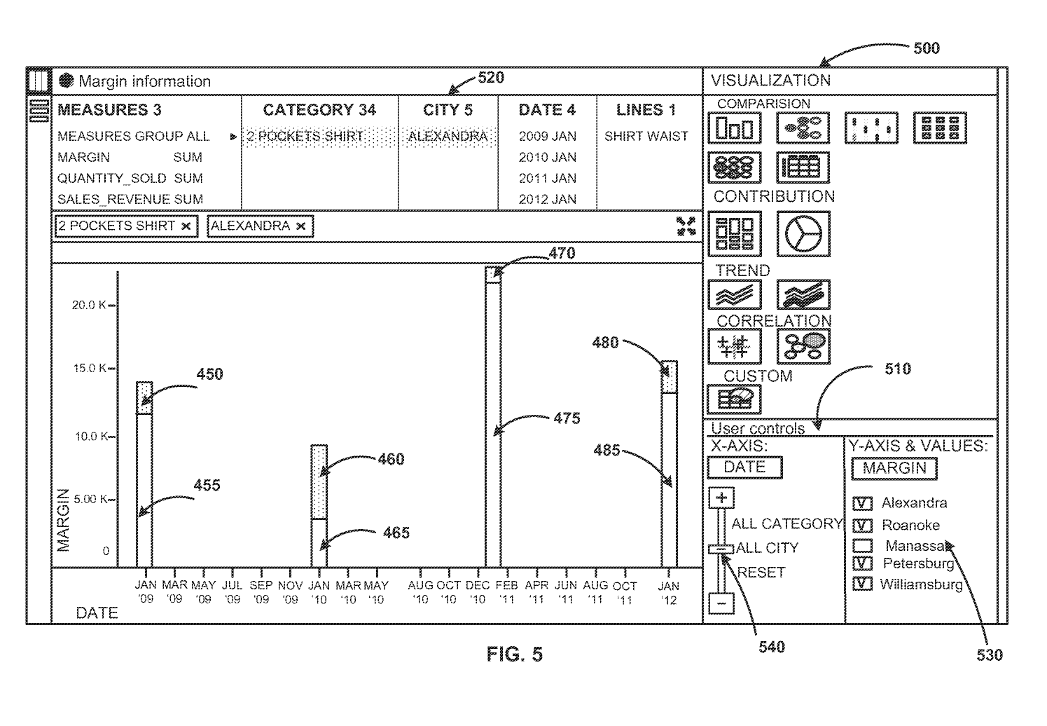

FIG. 5 is an exemplary screenshot, depicting an embodiment of an environment 500 for visualizing two BI reports, generated for comparative study, with the use of hierarchical navigation controls. User controls 510 are provided by the environment 500, which may be a BI application, such as the BI application 105 in FIG. 1. In one embodiment, BI reports may be generated with the use of the user controls 510, such as the two BI reports visualized in FIG. 4 using the user controls 310. The first BI report, such as the first BI report discussed in FIG. 4, may be generated for displaying margin information for a product “2 pockets shirt” sold in city “Alexandra”. The user controls 510 may be used to generate a second enhanced BI report, corresponding to the second BI report generated and visualized in FIG. 4. The second enhanced BI report may be a comparative report that is generated for other cities, not only “Alexandra”, to compare margin information. If a hierarchy navigation control 540 part of the navigation panel 510 is moved to the second position “ALL CITY”, then a detailed navigation panel 530 may be displayed that allows additional specification for the filtering of the CITY 520 dimension. The second enhanced BI report may differ from the second BI report discussed in FIG. 4 by the level of detail that is used when defining the cities relevant to the report. In the detailed navigation panel 530, all of the cities may be selected or, for example, just the rest of the cities may be selected that are in the used BI data, apart from the city used for the first BI report. The CITY 520 dimension includes five data values for different cities, where the company, providing the BI data used for the generation of the two reports, operates. There are values presented for the City 520 dimension within the detailed navigation panel 530—Alexandra, Roanoke, Manassas, Petersburg, Williamsburg. The values may be presented with check boxes, with a drop-down menu, or other. The detailed navigation panel 530 suggests a user to select a number of cities, including the city of Alexandra. In one embodiment, the salesperson that generates the first BI report for his own performance may compare his performance with the achieved results (e.g. margin information) for another city, e.g. Roanoke. A user may select any number of cities from the detailed navigation panel 530.

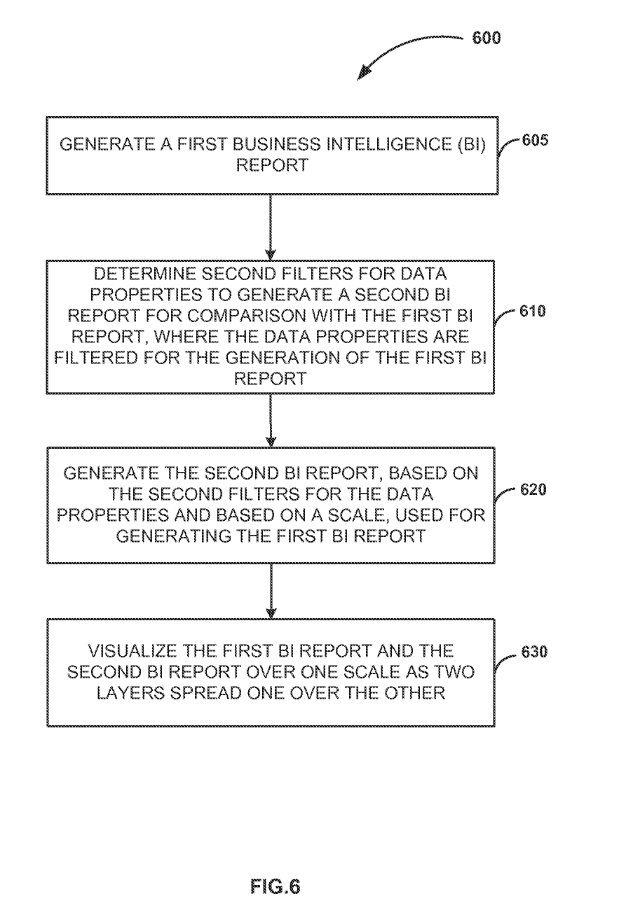

FIG. 6 is a flow chart, depicting an embodiment of a method 600 for generation and visualization of BI reports for comparative study. At step 605, a first BI report is generated, such as for example the first BI report 110 in FIG. 1. At step 610, second filters for data properties are determined in order to generate a second BI report. The second BI report may be a comparative report to the first BI report. The data properties that are chosen to be filtered with the second filters for the second BI report are the same as the data properties that are filtered when the first BI report is generated. At step 620, based on the defined second filters and a scale, the second BI report is generated. In one embodiment, the second BI report may be presented over the same scale, as the scale used for generating and presenting the first BI. At step 630, the first BI report and the second Bi report are visualized over a common scale as overlapping layers that are placed one over another.

In one embodiment, the first BI report and the second BI report may correspond to the first and second BI reports presented in FIG. 4 and discussed above. In the above example, the data properties that are filtered for both of the reports are the CATEGORY dimension and the CITY dimension. The defined filters for the first BI report in FIG. 4 are displayed in the filtering section 440, and the change in the filtering criteria for a data property is made with a selection (move up or down) of a navigation control 420 in the user controls 310 section. The used scale for the first BI report and the second BI report in FIG. 4 is the same—the x-axis is Date and the y-axis is Margin. The scale is firstly determined when generating the first BI report, and the second BI report, as a comparative report uses the same scale. The bars from the bar charts, representing the first BI report and the second BI report are placed at one and the same point over the x-axis (part of the scale), because the reports are generated based on one data source including BI data. In such a manner, the visualization of the two reports may be useful when comparing margin information for different cities, products categories, etc.

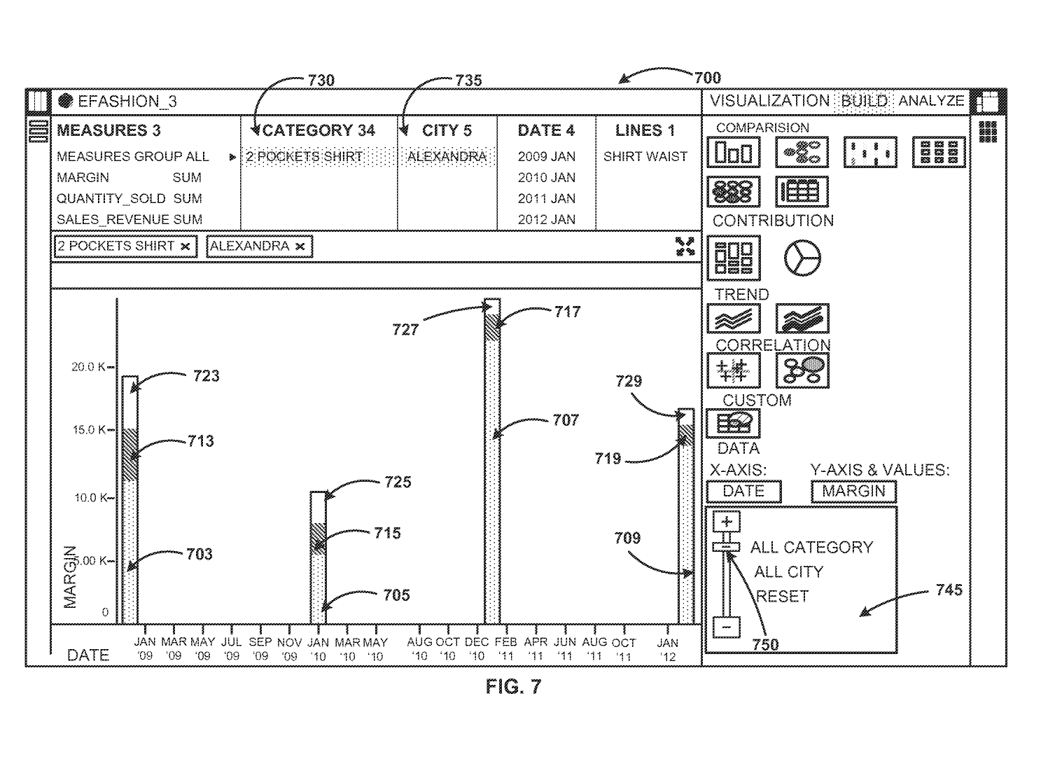

FIG. 7 is an exemplary screenshot, depicting an embodiment of an environment 00 of a BI application for visualizing multiple BI reports, with the use of switching controls provided by a graphical user interface. In one embodiment, the environment 700 may be an environment of a BI application that receives BI data from different data sources, presents data properties of the received BI data, and accommodates the generation and visualization of BI reports for comparative study. Bars 703, 705, 707, and 709, start from the x-axis “Date” and occupy the dotted area. The bars 703, 705, 707, and 709 may be part of a first BI report, such as the first BI report in FIG. 5 and FIG. 4 (bars 455, 465, 475, and 485). Bars 713, 715, 717, and 719, starting from the x-axis “Date” and occupying the dotted area and the line-crossed area, may be part of a second BI report, such as the second BI report in FIG. 5 and. FIG. 4 (bars 450, 460, 470, and 480).

In one embodiment, the first BI report in FIG. 7 may be generated by applying filtering on BI data having different data properties, such as measures and dimensions. For example, the filters for the first BI report may be defined for a Category 730 dimension and a City 735 dimension. The defined filtering criteria may be displayed at a filtering section 740—the category is “2 pockets shirt” and the city is “Alexandra”. The first BI report in FIG. 7 may be generated based on a scale including margin information on the y-axis and date information of x-axis. The second BI report in FIG. 7 may be generated based on the same BI data as the first BI report and the same scale. Also, during the generation of the second BI report, filtering is applied over the same data properties of the BI data that are used for the first BI report—Category 730 dimension and City 735 dimension. For example, second BI report is generated by means of user controls 745 that allow a user to switch into the hierarchy levels of the data, filtered for a given report. For example, the second BI report is generated by moving a hierarchy navigation control 750, such as the hierarchy navigation control 540 in FIG. 5, to the second position—ALL CITY. By zooming to the lower filtering (the second one) for the first BI report, more data is used for generating the second BI report, that present margin information for other cities where the category “2 pockets shirts” is sold.

In one embodiment, if the navigation control 750 is moved up to the position ALL CATEGORIES, a third BI report may be generated. The third BI report may zoom into all of the defined filtering for the first BI report, as the filtering in the example is on two data properties. In another embodiment, if the first BI report was generated based on filtering on more than 2 data properties, e.g. four filtered data properties, the scale in the user controls 745 may include the number of filtered data properties. Therefore, the scale may include four points. For generating the third BI report, the navigation control 750 is moved up, for example by a selection of a mouse click. The positioning of the navigation control 750 to the highest hierarchy level, defined within the filtering section 740, may result in generating a report that presents margin information not only for all of the cities that persist in the City 735 dimension, but also for all of the products that are present in the Category 730 dimension. The third BI report may be a comparative report that proposes information for achieved financial results (margin information) of a company based on the achieved sales in all of the cities where it the company operates, and all of the products that are part of company's product catalog. In one embodiment, the third BI report may be presented on the same scale as the scale used for the generation of the first and the second BI report. The scale includes 2 dimensions—x-axis, which is Date dimension, and y-axis, which is Margin measure. The third BI report may be displayed as four bars, such as bars 723, 725, 727, and 729. The bars 723, 725, 727, and 729 start at the x-axis and in the current example are higher than the bars for the second BI report. In another embodiment, the bars for the third BI report may be lower than the bars of other BI reports presented on the same scale and screen. In such cases, the visualization of the bars may be accomplished with different colors, shading or marks, so that the identification of the bars and which report they belong to is clear and understandable.

In one embodiment, the visualized BI reports are presented as bar charts, and the bars are visualized in 2-dimensional perspective in a coordinate system, having x and y axis. In another embodiment, the visualization of the BI reports may be in 3-dimensional perspective in a coordinate system, or N-dimensional, etc. The first BI report includes margin information that has an aggregation type sum. In some embodiment, the second BI report may include margin information for other cities, apart from “Alexandra”, and such information may have an aggregation type sum, or other, such as average. The aggregation type of the margin information for the second BI report may differ depending on the goals of the performed comparison analysis. If the purpose of the generation of the first and the second BI report is to compare the achieved margin for city “Alexandra”, with the average margin for other cities, where product “2 pockets shirt” is for sale, then the aggregation type for the second BI report is average. In another embodiment, a user may choose between different options of aggregation types when generating a given report. For example, a GUI of a BI application, such as the displayed GUI for the BI application displayed in FIG. 7, may include controls, such as menus, check boxes, text boxes, etc. to allow a user to choose between different options of aggregation types that suits their business scenarios. In such a manner, the three layers of BI reports that are places one over another may have different aggregation types for the presented information on the charts. The visualization of the overlaying reports makes the process of comparison between reports easier and more accurate. In some embodiments, the visualized reports may not be limited to the numbers or type of data presented in the examples herein.

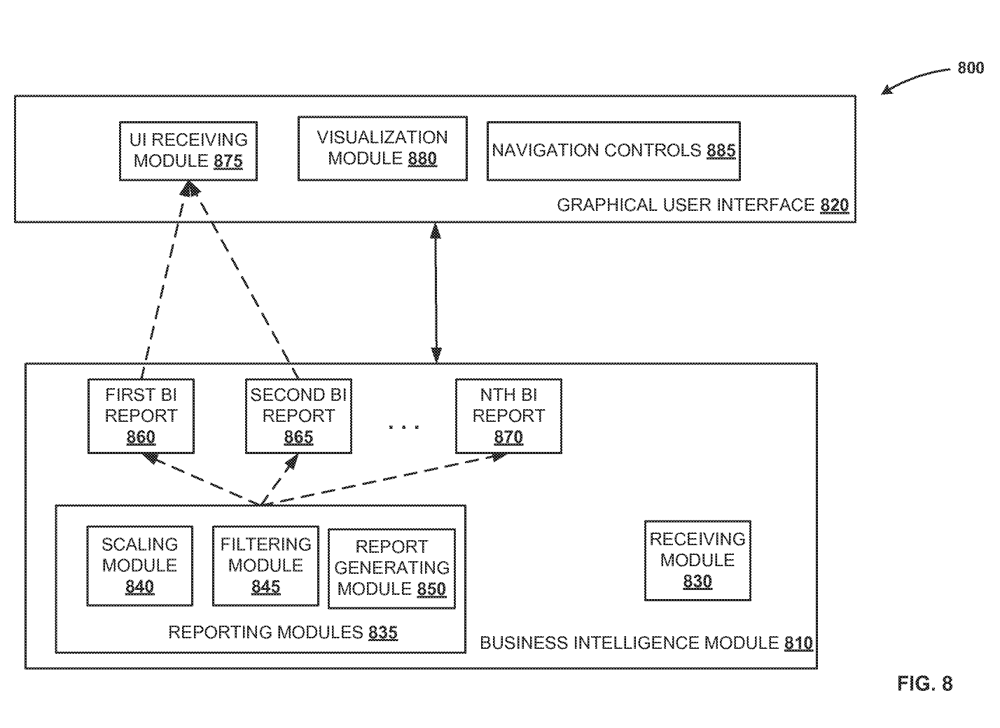

FIG. 8 is a block diagram, depicting an embodiment of a system 800 for generating multiple BI reports by means of hierarchical navigation controls. In one embodiment, the generated BI reports may be such as the discussed first, second and third BI reports in FIG. 7. A business intelligence (BI) module 810 is part of the system 800 and is in communication with a GUI 200. The BI module 810 receives BI data from data sources, and based on the BI data, a report may be generated. The BI module 810 may include a receiving module 830 to receive the BI data with data properties such as dimensions and measures. In one embodiment, the report may be generated for a comparative study and visualized in the GUI 820 as overlapping layers placed one on top of the other. The BI module 810 may be such as the BI module 220 in FIG. 1. The BI module 810 includes reporting modules 835 such as a scaling module 840, a filtering module 845, and a report generating module 850. In one embodiment, the scaling module 840 implements logic that allows determining of a scale for generating a BI report, such as the first BI report 110, FIG, 1. The filtering module 845 determines filters for data properties of the BI data that is used for generating reports. The data properties may be classified as dimensions and measure. The report generating module 850 incorporates logic for generation of BI reports based on the filtering, defined in the filtering modules 845, and the BI reports may be presented over a scale generated in the scaling module 840. For example, for the generation of multiple BI reports for a comparative study, one and the same scale may be used, common data sources may be used, but the filtering over the data properties of the data may be different. The reporting modules 835 may generate the first BI report 860, the second BI report 865, up to the Nth BI report 870. The generated first BI report 860, second BI report 865, up to the Nth BI report 870, may be received from a UI receiving module 875 to be presented in the GUI 820. The GUI 820 may include also a visualization module 880 that takes the received reports and visualizes them on a screen, for example, on a coordinate system. The reports may be visualized as charts, graphs, etc. The GUI 220 may include navigation controls 885, including hierarchy navigation controls, such as the hierarchy navigation control 540 (FIG. 5) for looking into a specific direction of a given report

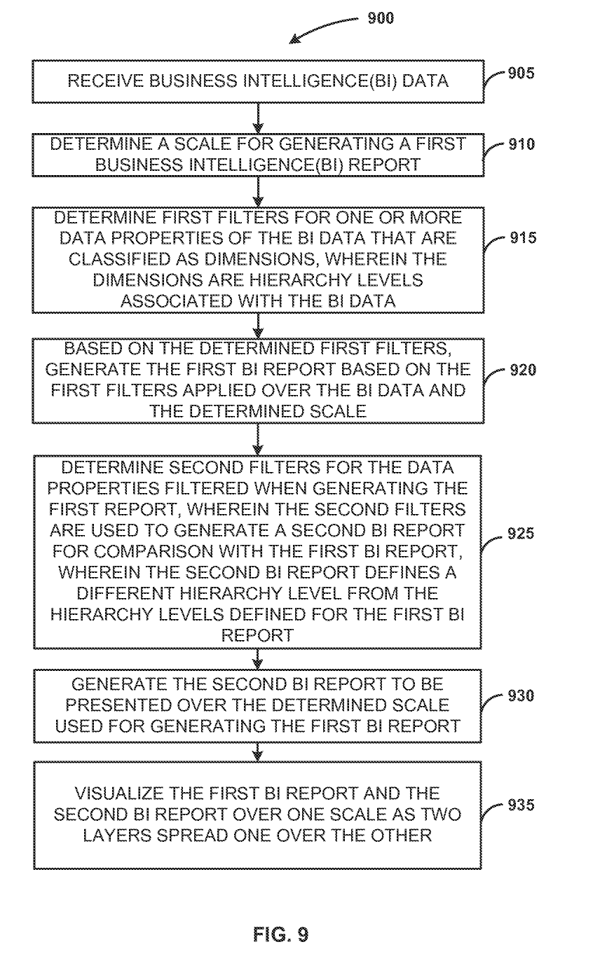

FIG. 9 is a flow chart, depicting an embodiment of a method 900 for generation of two BI reports over comparative BI data, sharing a common scale and different filters for common data properties. At step 905, BI data is received from data sources and at step 910, a scale is determined for generating a first BI report. At step 915, filters for one or more data properties are determined. The filters are applied for data properties that are classified as dimensions, which define hierarchy levels associated with the BI data. At step 920, the first BI report is generated, based on the determined filters, over the determined scale. For example, the first BI report is such as the first BI report discussed during the description of FIG. 4, FIG. 5, etc. Second filters (filtering criteria for defined set of data properties) are defined for data properties that are filtered when generating the first BI report at step 925. The second filters may be used for generating a second BI report that may be used for comparison with the first BI report. The second BI report may use the scale already determined for the first BI report. For example, the second BI report is such as the second BI report discussed during the description of FIG. 4, FIG. 5, etc. When defining the second filters, different hierarchy level from the first hierarchy levels, defined during filtering the data properties for the first BI report, are determined. At step 930, the second BI report is generated to be presented over the determined scale for the first BI report. At step 935, the first BI report and the second BI report are visualized over a common scale as two layers presented one over another, as displayed for example in FIG. 5.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

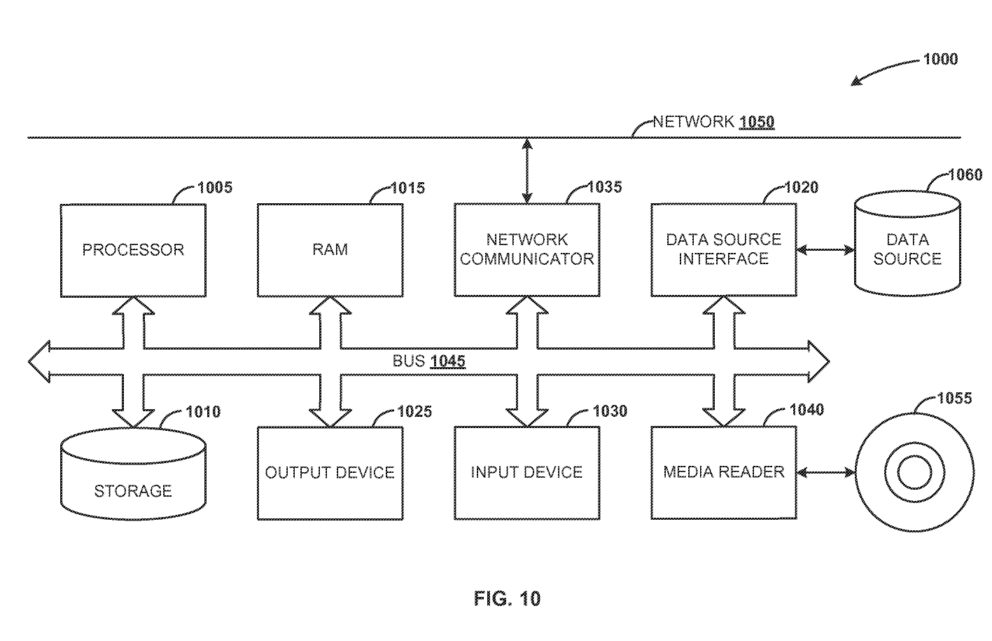

FIG. 10 is a block diagram of an exemplary computer system 1000. The computer system 1000 includes a processor 1005 that executes software instructions or code stored on a computer readable storage medium 1055 to perform the above-illustrated methods. The processor 1005 can include a plurality of cores. The computer system 1000 includes a media reader 1040 to read the instructions from the computer readable storage medium 1055 and store the instructions in storage 1010 or in random access memory (RAM) 1015. The storage 1010 provides a large space for keeping static data where at least sonic instructions could be stored for later execution. According to some embodiments, such as some in-memory computing system embodiments, the RAM 1015 can have sufficient storage capacity to store much of the data required for processing in the RAM 1015 instead of in the storage 1010. In some embodiments, all of the data required for processing may be stored in the RAM 1015. The stored instructions may be further compiled to generate other representations of the instructions and dynamically stored in the RAM 1015. The processor 1005 reads instructions from the RAM 1015 and performs actions as instructed. According to one embodiment, the computer system 1000 further includes an output device 1025 (e.g., a display) to provide at least some of the results of the execution as output including, but not limited to, visual information to users and an input device 1030 to provide a user or another device with means for entering data and/or otherwise interact with the computer system 1000. Each of these output devices 1025 and input devices 1030 could be joined by one or more additional peripherals to further expand the capabilities of the computer system 1000. A network communicator 1035 may be provided to connect the computer system 1000 to a network 1050 and in turn to other devices connected to the network 1050 including other clients, servers, data stores, and interfaces, for instance. The modules of the computer system 1000 are interconnected via a bus 1045. Computer system 1000 includes a data source interface 1020 to access data source 1060. The data source 1060 can be accessed via one or more abstraction layers implemented in hardware or software. For example, the data source 1060 may be accessed by network 1050. In some embodiments the data source 1060 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text tiles, screen scrapings), hierarchical data (e.g., data in a file system, XML data), files, a plurality of reports, and any other data source accessible through an established protocol, such as, Open DataBase Connectivity (ODBC), produced by an underlying software system e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the invention are described herein for illustrative purposes, various equivalent modifications are possible within the scope of the invention, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method for performing a comparative study over business intelligence data, the method comprising:
generating a first business intelligence report based on filtered business intelligence data;
determining one or more second filters for one or more data properties of the business intelligence data, to generate a second business intelligence report for comparison with the first business intelligence report, wherein the one or more data properties are filtered when generating the first business intelligence report;
generating the second business intelligence report based on the one or more second filters, applied over the business intelligence data, and based on a scale, determined for the generation of the first business intelligence report; and
displaying the first business intelligence report the second business intelligence report as two layers placed one over another.

2. The method of claim 1, wherein the one or more data properties that are filtered when generating the first business intelligence report and the second business intelligence report are classified as dimensions that define hierarchy levels associated with the business intelligence data.

3. The method of claim 2, wherein the second business intelligence report defines different hierarchy levels from first hierarchy levels, defined during filtering the one or more data properties for the first business intelligence report.

4. The method of claim 1, wherein generating the first business intelligence report comprises:
receiving the business intelligence data for the comparative study, wherein data properties of the business intelligence data are classified as measures and dimensions;
determining the scale for generating the first business intelligence report;
determining one or more first filters for the one or more data properties from the data properties classified as dimensions for generating the first business intelligence report: and
generating the first business intelligence report based on the one or more first filters applied over the business intelligence data and the determined scale.

5. The method of claim 4, wherein a data property classified as a measure has an aggregation type.

6. The method of claim 1, where the scale includes quantitative data properties.

7. The method of claim 4, wherein the determined scale is applied over a coordinate system when displaying the first business intelligence report and the second business intelligence report.

8. The method of claim 1, wherein the first business intelligence report and the second business intelligence report are displayed in a graphical user interface (GUI).

9. The method of claim 7, further comprising:
displaying a set of business intelligence reports, together with the first business intelligence report and the second business intelligence report, as multiple layers placed one over another, wherein the set of business intelligence reports presents different aspects of the business intelligence data defined by filtering the business intelligence data and presenting the filtered data on the determined scale for generating the first business intelligence report in the GUI.

10. A computer system for performing a comparative study over business intelligence data, comprising:
a server module to receive the business intelligence data from one or more data sources:
a business intelligence module running on the server module to:
generate a first business intelligence report based on filtered business intelligence data presented;
determine one or more second filters for one or more data properties of the business intelligence data to generate a second business intelligence report for comparison with the first business intelligence report, wherein the one or more data properties are filtered hen generating the first business intelligence report; and
generate the second business intelligence report based on the one or more second filters, applied over the business intelligence data, and based on a scale, determined for the generation of the first business intelligence report; and
a graphical user interface to:
receive the first business intelligence report and the second business intelligence report from the business intelligence module via the server module; and
display the first business intelligence report and the second business intelligence report as two layers placed one over another.

11. The system of claim 10, wherein the one or more data properties that are filtered when generating the first business intelligence report and the second business intelligence report are classified as dimensions that define hierarchy levels associated with the business intelligence data.

12. The system of claim 10, wherein the business intelligence module comprises:
a receiving module to receive the business intelligence data for the comparative study, wherein data properties of the business intelligence data are classified as measures and dimensions;
a scaling module to determine the scale for generating t first business intelligence report;
a filtering module to determine one or more first filters for the one or more data properties from the data properties classified as dimensions for generating the first business intelligence report; and
a report generating module to generate the first business intelligence report based on the one or more first filters applied over the business intelligence data and the determined scale.

13. The system of claim 10, wherein a data property classified as a measure has an aggregation type.

14. The system of claim 12, wherein the graphical user interface comprises hierarchical navigation controls to generate and display the second business intelligence report, keeping the display of the first business intelligence report intact, by switching a filter for at least one of the data properties filtered during generation of the first business intelligence report, and wherein the second business intelligence report defines different hierarchy levels from first hierarchy levels defined during filtering the one or more data properties.

15. The system of claim 10, wherein the second business intelligence report presents a different hierarchical level of data from the business intelligence data compared to the first business intelligence report.

16. An article of manufacture for performing a comparative study over business intelligence data, comprising a non-transitory computer readable storage medium including executable instructions, which when executed by a computer, cause the computer to:
generate a first business intelligence report based on filtered business intelligence data;
determine one or more second filters for one or more data properties of the business intelligence data to generate a second business intelligence report for comparison with the first business intelligence report, wherein the one or more data properties are filtered when generating the first business intelligence report;
generate the second business intelligence report based on the one or more second filters, applied over the business intelligence data, and based on a scale, determined for the generation of the first business intelligence report;
display the first business intelligence report and the second business intelligence report as two layers placed one over another; and
display a set of additional business intelligence reports, together with the first business intelligence report and the second business intelligence report, as multiple layers placed one over another, wherein the set of additional business intelligence reports presents different aspects of the business intelligence data defined by filtering the business intelligence data and present he filtered data on the determined scale for generating the first business intelligence report on a graphical user interface.

17. The computer-readable medium of claim 15, wherein the one or more data properties that are filtered when generating the first business intelligence report and the second business intelligence report are classified as dimensions that define hierarchy levels associated with the business intelligence data.

18. The computer-readable of medium of claim 15, wherein the second business intelligence report defines different hierarchy levels from first hierarchy levels, defined during filtering the one or more data properties for the first business intelligence report.

19. The computer-readable medium of claim 15, wherein the instructions to generate the first business intelligence report further comprise instructions, which when executed by a computer, cause the computer to:
receive the business intelligence data for the comparative study, wherein data properties of the business intelligence data are classified as measures and dimensions;
determine the scale for generating the first business intelligence report;
determine one or more first filters for the one or more data properties from the data properties classified as dimensions for generating the first business intelligence report; and
generate the first business intelligence report based on the one or more first filters applied over the business intelligence data and the determined scale.

20. The computer-readable medium of claim 17, wherein a data property classified as a measure has an aggregation type.
